(19) United States
(12) Patent Application Publication
(10) Pub. No.: US 2006/0163940 A1
(43) Pub. Date: Jul. 27, 2006

(54) Process and device for management of inside and outside braking for a decelerating vehicle taking a bend

(76) Inventors: Belen Alvarez, Paris (FR); Xavier Marie Groult, Survilliers (FR); Philippe Blaise, Dampiere les Bois (FR)

Correspondence Address: DELPHI TECHNOLOGIES, INC., M/C 480-410-202, PO BOX 5052, TROY, MI, 48007, US

(21) Appl. No.: 11/188,573

(22) Filed: Jul. 25, 2005

(30) Foreign Application Priority Data
Jul. 26, 2004 (EP) 04291895.3

(51) Int. Cl. B60T 8/60

(52) U.S. Cl. 303/146

(57) ABSTRACT

A braking process to increase the stability of a vehicle taking a bend while the driver is braking in which the activation of the brakes of the rear wheels is decoupled from depression of the pedal, the process including: detecting an entry condition including a bend test and a braking test; and, while the entry condition is verified, determining a base braking force from the depression of the brake pedal; correcting the base force to obtain a corrected force smaller than the base force; modulating the corrected force to obtain a reference force smaller than the corrected force; and applying the corrected braking force to the outside rear wheel and the reference braking force to the inside rear wheel.

### TECHNICAL FIELD

The field of the invention is that of functions for managing the braking of a vehicle fitted with a braking system in which the activation of the brake calipers is decoupled from effective depression of the brake pedal by the driver. More particularly, the field of the invention is that of the functions intended to increase the stability of the vehicle entering a bend or engaged in a bend.

### BACKGROUND OF THE INVENTION

In a bend, centrifugal acceleration is the cause of a lateral load transfer of the suspended masses of the vehicle from the inside of the bend towards the outside, causing a rolling motion of the body. Consequently, the distribution of the vehicle weight on the wheels is modified and the reaction of the road on the wheels situated on the inside of the bend, or inside wheels, tends to decrease while the reaction of the road on the wheels situated on the outside of the bend, or outside wheels, tends to increase. The braking force, a magnitude correlated with the reaction of the road, which it is necessary to apply to an inside wheel to stop its rotational motion is smaller than the braking force which it is necessary to apply to an outside wheel. In an extreme case, the transfer of load is such that the inside wheel loses contact with the road and a braking force of a few Newtons is sufficient to stop its rotational motion.

When the driver brakes in a bend, if the braking force required by the driver were applied directly to the inside wheels, this would increase their slip, with a high probability of causing them to lock.

Moreover, if the wheel is in slipping contact with the road, the lateral tangential component of the reaction of the ground on the wheel is brought to zero. Now it is precisely this component which allows the vehicle to turn and follow a curved trajectory. The tyre then loses its lateral power relative to the ground, and this the more so as a braking force, which is a longitudinal tangential force, is applied to the tyre so as to increase slip of the wheel. In other words, the vehicle can either brake a lot or turn a lot. Therefore, slip of the inside wheel on braking causes a loss of lateral power of the tyre and therefore instability of the vehicle which tends to open its trajectory.

It is known to provide vehicles with a function known as stability control (ESP for “Electronic Stability Program”) controlling the stability of the vehicle on bends. The yaw angle is the angle between the longitudinal axis of the vehicle and the tangent to the trajectory required by the driver. This is determined, inter alia, by the steering wheel lock angle. When the yaw angle is too large, the stability control function triggers either application of an additional drive torque or additional braking. This additional braking applied to one of the wheels creates a moment about the yaw axis, the vertical axis passing through the centre of gravity of the vehicle. This additional moment has the effect of causing the vehicle to turn about the yaw axis and reducing the yaw angle so as to readopt a stable trajectory.

The stability control function, which is a safety function, is a function which is activated under extreme circumstances. The actuation thresholds have high values. Moreover, the mode of action consisting of braking one of the wheels heavily to return the vehicle to the correct trajectory is sharp. The vehicle passengers feel the actuation of the ESP function which is detrimental to their comfort.

### SUMMARY OF THE INVENTION

There is therefore a need for a braking system employing a process increasing the stability of the vehicle on bends at lesser cost, while the driver is braking, before the conditions for actuation of an ESP function all occur. The invention has as its object a braking management process to increase the stability of a vehicle on bends while the driver is depressing a brake pedal to attain required deceleration, the vehicle being provided with a braking system including brake calipers which can be activated as a function of a target braking force and in which at least the activation of the brake calipers which are fitted to the rear wheels is decoupled from depression of the brake pedal, including:

detecting a logical entry condition including at least a bend test and a braking test; and, while the logical entry condition is verified,

determining a base braking force from the required deceleration;

calculating, for the inside and outside wheels, a corrected braking force from the base braking force for the corrected braking force to be smaller than the base braking force;

modulating the corrected braking force, for the inside wheel, to obtain an inside reference braking force which is smaller than the corrected braking force; and

applying the corrected braking force as the target braking force for the outside rear wheel and the inside reference braking force as the target braking force for the inside wheel.

Preferably, in the step of detection of a logical entry condition, the braking test is verified when the brake pedal is depressed.

Preferably, in the step of calculation of a corrected base braking force, the base braking force is multiplied by a gain from which the corrected braking force results.

Preferably, the base gain is an increasing function of an instantaneous velocity of the vehicle. Again preferably, the base gain is a decreasing function of a lateral acceleration of the vehicle.

In one embodiment, the modulation step includes determining the temporal variation of lateral acceleration; comparing the variation in lateral acceleration with a threshold variation; and, when the variation in lateral acceleration is greater than the threshold variation, calculating a modulation gain which is smaller than unity and which is a decreasing function of the variation in lateral acceleration; and multiplying the corrected-braking force by the modulation gain to obtain the inside reference braking force.

The invention also has as its object software for braking management containing instructions suitable to be read from and stored on a support, the instructions being executable by a host computer, wherein the software employs a process as described above.

The invention has as its object a programmable braking controller employing a process as described above, in a vehicle provided with a braking system including brake calipers able to be activated as a function of a target braking force and in which at least the activation of the brake calipers fitted to the rear wheels is decoupled from depression of a brake pedal, which depression corresponds to a deceleration required by the driver, the controller including a memory space able to store software instructions, a computer able to execute the instructions and an input/output interface connectable at its input to a plurality of sensors with which the vehicle is fitted and at its output to units for brake caliper activation, wherein the controller is programmed to include:

a means for detection of a logical entry condition including a means for testing a bend condition and a means for testing a braking condition, the means for testing a bend condition permitting verification that a lateral acceleration measured by an acceleration sensor is greater than a threshold lateral acceleration, and the means for testing a braking condition permitting verification that the brake pedal is depressed;

a means for determination of a base braking force from the required deceleration;

a means for calculation of a corrected braking force able to correct the base braking force so that the value of the corrected braking force is smaller than the value of the base braking force;

a modulation means able to modulate the corrected braking force as a function of a variation in lateral acceleration so as to obtain an inside reference braking force which is smaller than the corrected braking force; and

a means for transmission of the corrected braking force as target braking force for the outside rear wheel, and of the inside reference braking force as the target braking force for the inside rear wheel.

The invention also has as its object a vehicle braking system including a braking controller, units for activation of brake calipers and at least electromechanical brake calipers fitted to the rear wheels of the vehicle, wherein the braking controller is a programmable braking controller as described above.

The invention has as its object a vehicle including a braking system as described above.

### BRIEF DESCRIPTION OF THE DRAWINGS

The invention will be better understood and other aims, details, characteristics and advantages of it will become more clearly apparent in the course of the following description of a particular embodiment of the invention given solely in illustrative and non-limiting manner, with reference to the attached drawings. In these drawings:

FIG. 1 shows diagrammatically a vehicle fitted with a hybrid braking system;

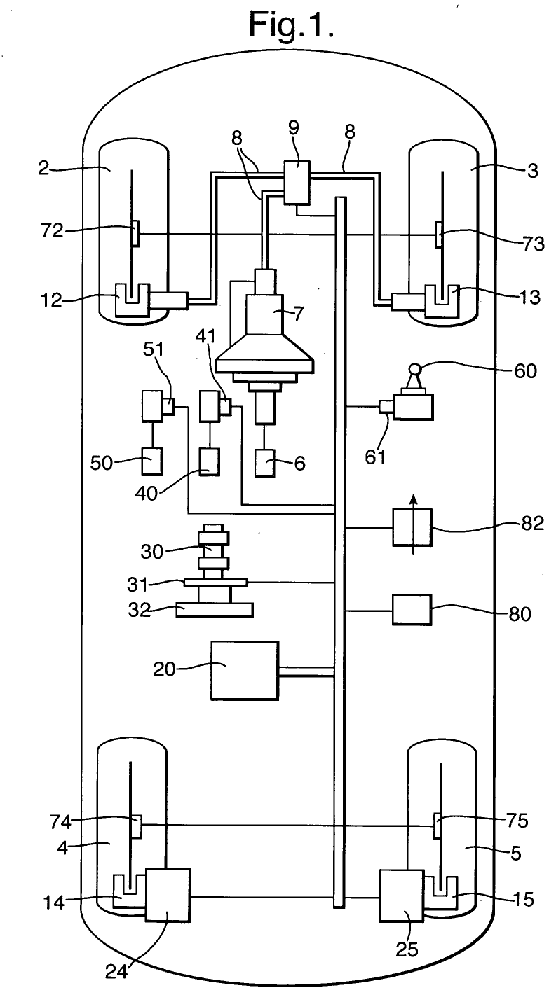

FIGS. 2A, 2B and 2C show, in the form of flow-charts, the different steps of an embodiment of the process in accordance with the invention;

FIG. 3 shows a family of curves, indexed by the lateral acceleration, giving the base gain as a function of the velocity of the vehicle; and

FIG. 4 shows the braking forces and velocities of the inside and outside rear wheels in the course of a test in which the process in accordance with the invention is active.

### DESCRIPTION OF THE PREFERRED EMBODIMENT

The increase in stability in a bend occurs by reduction of the value of the braking force effectively applied to the inside wheels. Thus, an inside wheel will be less subject to slip and a vehicle will retain its ability to take the bend and its stability to the maximum extent.

Since the braking force effectively applied to the inside wheels does not correspond to the braking force required by the driver, the process in accordance with the invention can only be implemented in a vehicle including a braking system decoupled from operation of the brake pedal, at least for activation of the brake calipers fitted to the rear wheels. The vehicle in which the invention is implemented is preferably a vehicle including a hybrid braking system, but could also be a vehicle including an entirely electronically managed braking system.

A vehicle 1 includes two front wheels 2 and 3 and two rear wheels 4 and 5. The hybrid braking system includes a brake pedal 6 connected to a master-cylinder 7. When the brake pedal 5 is depressed by the driver wishing the vehicle to be braked, the master-cylinder 7 generates an hydraulic over-pressure which is propagated via the hydraulic unit 9 and the piping 8 to the hydraulic brake calipers 12 and 13 fitted to the front wheels 2 and 3 respectively.

The rear wheels 4 and 5 are respectively fitted with electromechanical calipers 14 and 15. When the driver presses on the brake pedal 6, the hydraulic unit 9 also emits an electrical signal S corresponding to the over-pressure generated by the master-cylinder 7, indicating the value of the longitudinal deceleration D_{L} required by the driver.

The electrical signal S is applied to an input of a braking controller 20. The braking controller 20 includes at least a computer and a memory. The memory is able to store the instructions of different programs. The computer is able to execute these instructions. The controller 20 includes an input/output interface permitting at its input acquisition of signals from different sensors and storage of the corresponding values in pre-defined memory spaces, and permitting at its output the emission of signals as a function of values read from pre-defined memory spaces.

In response to the signal S, the controller 20 determines whether the brake pedal is depressed (for example S different from the value zero). Then, if such is the case, the controller 20 periodically calculates the inside and outside braking forces having to be applied by the inside 14 and outside 15 calipers respectively. The controller 20 transmits at its output control signals corresponding to the target braking forces to remote actuators 24 and 25 controlling the activation of the rear calipers.

More precisely and in known manner, calculation by the controller 20 of a target braking force consists firstly of determining a base braking force from the deceleration required by the driver and which corresponds to the depression of the brake pedal, and then applying different functions in order to modulate the base braking value. For example, a wheel anti-skid function corrects the base braking force as a function of the value of the instantaneous slip of the wheels. For example gain, a stability control function can increase the base braking force at one of the wheels to increase the stability of the vehicle engaged in a bend. Each of these functions, triggered as a function of particular entry conditions, leads to the calculation of a reference braking force and of a flag indicating the priority level of the reference braking force thus calculated. Finally, an arbitration device allocates the value of the reference braking force having the highest priority to the target braking force to be transmitted to the corresponding caliper.

Moreover, the vehicle 1 is provided with a plurality of sensors permitting measurement of the instantaneous value of different variables, so as to define an instantaneous state of the vehicle. The steering column 30 is, for example, provided with a sensor 31 permitting measurement of the angle of lock which the driver is applying to the steering-wheel 32. The angle of lock is zero when the driver wishes to go in a straight line and follow a rectilinear trajectory. The angle of lock is by convention negative (positive) when the driver wishes to turn to the left (right). In the remainder of this document, the bend is to the right and the wheels on the inside of the bend are consequently wheels 3 and 5. The accelerator pedal 40 includes a sensor 41 permitting measurement of the degree of depression of the accelerator pedal. The clutch pedal 50 includes a sensor 51 permitting determination of the state of engagement: a declutched state in which the engine is connected to the drive wheels, or a clutched state in which the engine is disconnected from the drive wheels and intermediate slip state in which the drive torque is only partially applied to the drive wheels. Lastly, the vehicle 1, if it has a manual gearbox 60, can be provided with a sensor 61 permitting knowledge of the position of the gear lever.

The vehicle 1 also includes sensors permitting determination of the kinematic state of the vehicle. Each of the wheels 2-5 is provided with a wheel velocity sensor 72-75 permitting measurement of the instantaneous rotational velocity of the wheel. This information allows the controller 20 to calculate an instantaneous velocity V of the vehicle. In order to measure acceleration, the vehicle includes for example a lateral acceleration sensor 80 and a longitudinal acceleration sensor 82. The different sensors described are connected to the controller 20 via a network, for example supporting the CAN-Bus protocol.

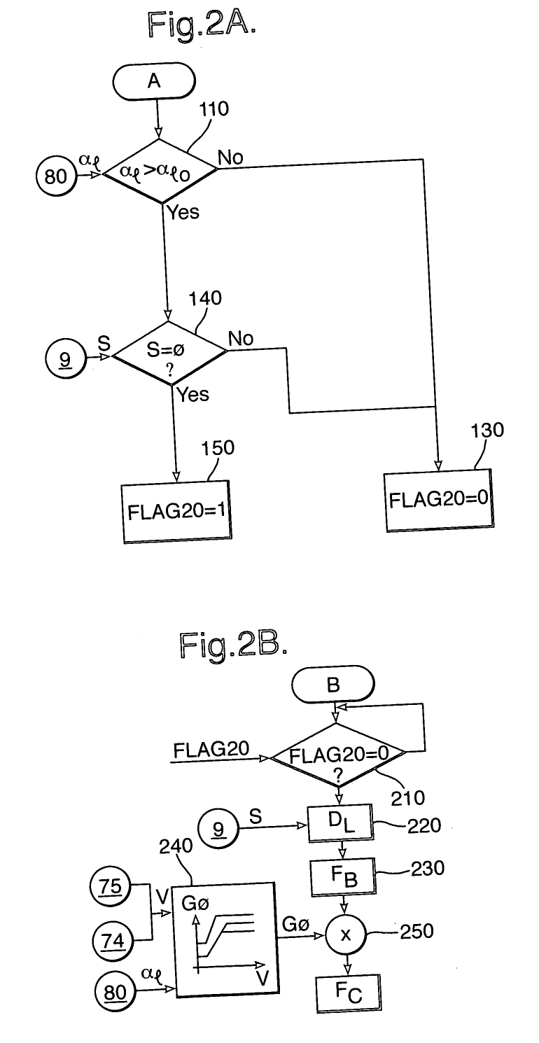

With reference now to FIGS. 2A, 2B and 2C, the different steps of the process in accordance with the invention will be described. Preferably, the process is implemented by the controller 20 executing software instructions in order to manage braking, the software instructions being stored in the memory of the controller 20.

In FIG. 2A, execution of the software starts with the execution of a module A for detection of a logical entry condition. When this logical entry condition is verified, the instantaneous state of the vehicle is compatible with management of braking by means of the process in accordance with the invention. The module A starts with a bend test: either the vehicle is already engaged in the bend at the moment when the driver brakes, or the vehicle is travelling in a straight line and is entering a bend. These two situations are indicated by the instantaneous lateral acceleration measured by the sensor 80. The bend test therefore includes a comparison 110 consisting of comparing the lateral acceleration value a₁ with a threshold lateral acceleration a₁₀ of 0.1 g for example. If the comparison 110 is not verified, in step 130 the execution of the module A allocates the value 0 to a flag FLAG20 thus indicating that the instantaneous state of the vehicle is not compatible with the braking management function in accordance with the invention.

Conversely, if the condition is verified, the bend test is followed by a braking test 140 permitting detection of whether the driver is depressing the brake pedal 6 in order to brake the vehicle. The braking test 140 consists of comparing the current value of the pressure signal S with the value zero. When the pressure signal is different from zero, this means that the driver is operating the brake pedal 6. When this braking test is not verified, execution of module A passes to step 130. Conversely, if this braking test 140 is verified, while the lateral acceleration condition is also verified, the value 1 is allocated to the variable FLAG20 in step 150.

Module A is executed periodically so as to determine whether the instantaneous state of the vehicle is compatible by taking over of the braking system by the function for braking in a bend in accordance with the invention.

It should be noted that if the driver brakes while the vehicle is already engaged in a bend, the management of braking is triggered so as to increase the stability of the vehicle. The management of braking is also triggered when it has been anticipated that the vehicle will enter a bend. In the currently preferred embodiment, anticipation of the bend is effected by means of lateral acceleration, but other variables can be taken into account to anticipate this situation.

Module B is shown in the form of a flow-chart in FIG. 2B. It is executed periodically. It starts with a step 210 consisting of testing the value of the flag FLAG20 read from a memory space having a predetermined address. If the flag FLAG20 indicates a state compatible with activation of the management of the brakes in accordance with the invention, execution of module B passes to step 220.

In step 220, the value of the pressure signal S permits determination of the value of the longitudinal deceleration D_{L} required by the driver. From the value of the deceleration D_{L}, a base braking force F_{B} is determined in step 230. Determination of F_{B} involves characteristics of the vehicle such as the mass of the bodywork, the stiffness of the suspension, etc.

If the base braking force F_{B} were directly applied as the target braking force to the rear wheels, and in particular to the inside rear wheel, there would be a high probability that the latter would start to slip. It is for this reason that a base gain G₀ is applied to the base braking force F_{B} in step 250 to obtain a corrected braking force F_{C}. The amplitude of the corrected braking force F_{C} is smaller than the amplitude of the base braking force F_{B}. In the embodiment currently envisaged, the corrected braking force is identical for the two rear wheels.

Step 240 permits determination of the value of the base gain G₀ as a function of the longitudinal velocity V and of the lateral acceleration a₁ of the vehicle. In the preferred embodiment, this determination is effected by means of calibration curves stored in the memory of the controller 20. In the case of a controller having greater calculating power, the base gain G₀ could be calculated using a function of the velocity V and the acceleration a₁.

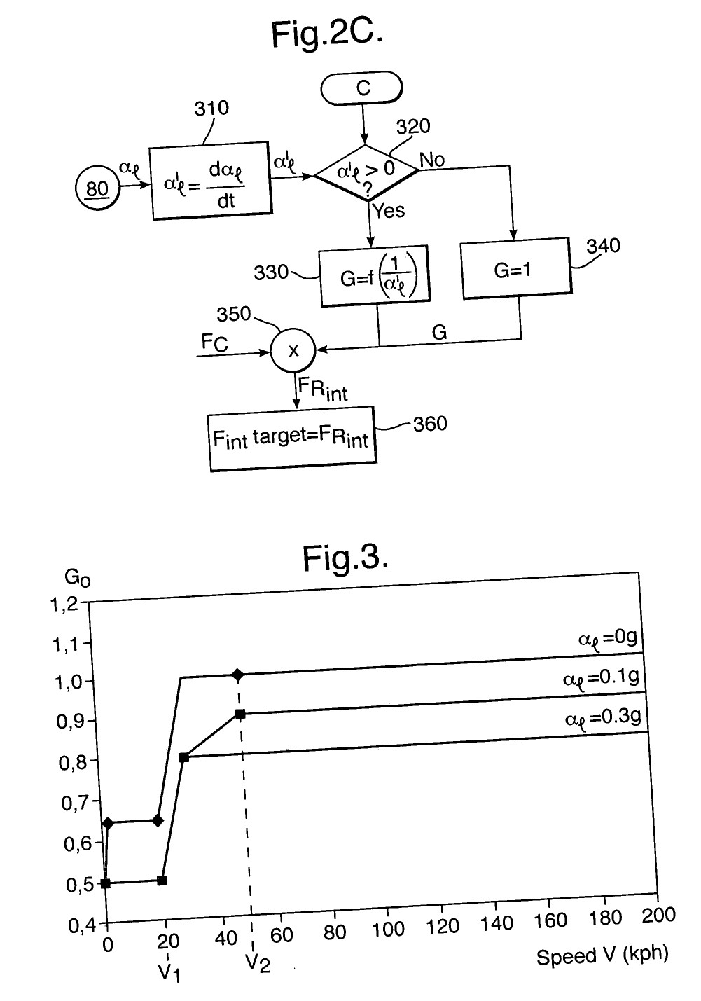

FIG. 3 shows a family of calibration curves indexed by values of the lateral acceleration a₁. These curves give the value of the base gain G₀ as a function of the instantaneous velocity V. Below a lower threshold velocity V₁, for example 20 kilometres per hour (km/h), at low velocity, the base gain is small. Above an upper threshold velocity V₂, for example 50 k/n/h, the base gain G₀ is constant and has the value of a maximum gain dependent on the lateral acceleration a₁, but always smaller than unity. The base gain G₀ is both an increasing function of the velocity V and a decreasing function of the acceleration a₁.

The corrected braking force F_{c} is a braking force which could be applied directly as target braking forces to the inside rear wheel and to the outside rear wheel. Preferably, a modulation function is used to calculate the inside target braking force from the value of the corrected braking force F_{c}. Such a modulation function is shown in FIG. 2C in the form of a flow-chart.

The modulation function uses the temporal variation in the lateral acceleration a₁ given by the sensor 80. The lateral acceleration variation a′₁ is calculated in step 310. Then the instantaneous value of the lateral acceleration variation a′₁ is compared, in step 320, with a reference acceleration variation which is here the value zero. If the lateral acceleration variation a′₁ is negative, the value of a modulation gain G is set at unity (step 340). Conversely, if the lateral acceleration variation a′₁ is strictly positive, the value of the modulation gain G is calculated in step 330 as a decreasing function of the lateral acceleration variation a′₁. The modulation gain G tends towards unity when the lateral acceleration variation a′₁ tends towards zero. The modulation gain G tends towards zero when the lateral acceleration variation a′₁ tends towards large values. In step 350, the corrected braking force F_{C} is multiplied by the value of the modulation gain G to determine an inside reference braking force F_{Rint}. In step 360, this inside reference braking force F_{Rint} is allocated to the target braking force F_{target} transmitted to the inside rear wheel. It is obvious to the man skilled in the art that other ways to modulate the corrected braking force can be envisaged and enter within the scope of the present invention.

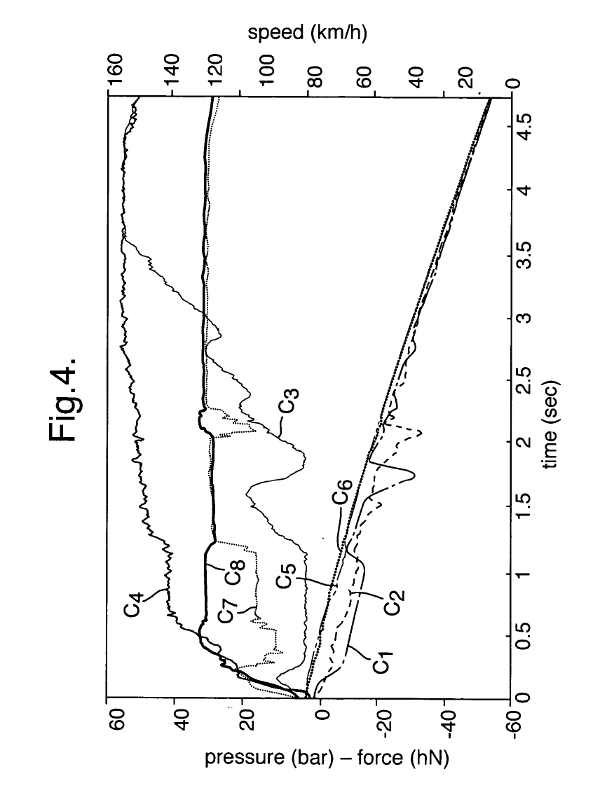

FIG. 4 shows curves representing the temporal evolution of kinematic magnitudes measured during a test performed on a vehicle implementing the process in accordance with the invention. In FIG. 4, the curve C₁ represents the velocity of the inside rear wheel (velocity close to the longitudinal velocity of the vehicle if slip and the wheel angle are not taken into account). The curve C₂ represents the velocity of the outside rear wheel. The curve C₃ represents the braking force effectively applied to the inside rear wheel. The curve C₄ represents the braking force effectively applied to the outside rear wheel, which corresponds to the corrected braking force F_{C}. The curves C₅ and C₇ (C₆ and C₈) correspond to the same physical magnitudes for the inside front wheel (for the outside front wheel). The effect of the modulation of the braking force on the inside wheel is revealed by the fact that the curve C₃ is below the curve C₄, and this as long as the lateral acceleration variation is positive.

In the currently preferred embodiment, braking management is identical in the case in which the vehicle is in a bend and then the driver brakes and in the case in which the driver brakes and then turns the steering-wheel to enter a bend; by way of modification, different braking management could be envisaged for the two situations.

Although the invention has been described in relation to a particular embodiment, it is quite obvious that it is in no way limited to it and that it includes all the technical equivalents of the means described and their combinations if these enter within the framework of the invention.

1. A braking management process to increase the stability of a vehicle on a bend while the driver is depressing a brake pedal to attain a required deceleration, the vehicle being provided with a braking system including brake calipers which can be activated as a function of a target braking force and in which at least the activation of the brake calipers which are fitted to the rear wheels is decoupled from depression of the brake pedal, comprising:
detecting a logical entry condition including at least a bend test and a braking test; and while the logical entry condition is verified,
determining a base braking force from the required deceleration;
calculating, for the inside and outside wheels, a corrected braking force from the base braking force for the corrected braking force to be smaller than the base braking force;
modulating the corrected braking force, for the inside wheel, to obtain an inside reference braking force which is smaller than the corrected braking force; and
applying the corrected braking force as the target braking force for the outside rear wheel and the inside reference braking force as the target braking force for the inside wheel.

2. The process of claim 1, wherein, in said detecting a logical entry condition, the bend test is verified when an instantaneous lateral acceleration of the vehicle is greater than a threshold lateral acceleration.

3. The process of claim 1, wherein, in said detecting a logical entry condition, the braking test is verified when the brake pedal is depressed.

4. The process of claim 1, wherein, in said calculating a corrected base braking force, the base braking force is multiplied by a gain resulting in the corrected braking force.

5. The process of claim 4, wherein the base gain is an increasing function of a longitudinal velocity of the vehicle and a decreasing function of a lateral acceleration of the vehicle.

6. The process of claim 1, wherein said modulating comprises:
determining the temporal variation in the lateral acceleration;
comparing the variation in lateral acceleration with a threshold variation; and, when the lateral acceleration variation is greater than the threshold variation,
calculating a modulation gain which is less than unity and which is a decreasing function of the lateral acceleration variation; and
multiplying the corrected braking force by the modulation gain to obtain the inside reference braking force.

7. Software for braking management containing instructions suitable to be read from and stored on a support, said instructions being executable by a host computer, wherein said software implements the process of claim 1.

8. A programmable braking controller implementing a process as described in claim 1 in a vehicle provided with a braking system including brake calipers able to be activated as a function of a target braking force and in which at least the activation of the brake calipers fitted to the rear wheels is decoupled from depression of a brake pedal, which depression corresponds to a deceleration required by the driver, said controller including a memory space able to store software instructions, a computer able to execute said instructions and an input/output interface connectable at its input to a plurality of sensors with which the vehicle is provided and at its output to brake caliper activation units, wherein said controller is programmed to include:
a means for detection of a logical entry condition including a means for testing a bend condition and a means for testing a braking condition, said means for testing a bend condition permitting verification that a lateral acceleration measured by an acceleration sensor is greater than a threshold lateral acceleration, said means for testing a braking condition permitting verification that the said brake pedal is depressed;
a means for determination of a base braking force from the required deceleration;
a means for calculation of a corrected braking force able to correct the said base braking force so that the value of the corrected braking force is smaller than the value of the base braking force;
a modulation means able to modulate the corrected braking force as a function of a lateral acceleration variation so as to obtain an inside reference braking force which is smaller than the corrected braking force; and
a means for transmission of the corrected braking force as target braking force for the outside rear wheel, and the inside reference braking force as target braking force for the inside rear wheel.

9. A braking system for vehicle including a braking controller, units for activation of brake calipers and at least electromechanical brake calipers fitted to the rear wheels of the vehicle, wherein said braking controller is the programmable braking controller of claim 8.

10. A vehicle including the braking system of claim 9.
